(19) United States
(12) Patent Application Publication
(10) Pub. No.: US 2025/0096502 A1
(43) Pub. Date: Mar. 20, 2025

(54) CONNECTOR AND CONNECTOR CONNECTION STRUCTURE

(71) Applicant: Yazaki Corporation, Tokyo (JP)

(72) Inventors: Takahiro KUBO, Makinohara-shi (JP); Shoichi NOMURA, Makinohara-shi (JP); Junpei HAYASHI, Kakegawa-shi (JP)

(73) Assignee: Yazaki Corporation, Tokyo (JP)

(21) Appl. No.: 18/964,951

(22) Filed: Dec. 2, 2024

Related U.S. Application Data
(63) Continuation of application No. PCT/JP2023/038146, filed on Oct. 23, 2023.

(30) Foreign Application Priority Data
Nov. 22, 2022 (JP) 2022-186745

(51) Int. Cl. H01R 13/518; H01R 13/6592

(52) U.S. Cl. CPC H01R 13/518; H01R 13/6592; H01R 2201/26

(57) ABSTRACT

A connector includes a plurality of electric wires with terminals; a connection portion that retains terminals of the plurality of electric wires with terminals to be collectively connectable to male terminals; and a plurality of housing portions that accommodate the terminals being retained by the connection portion respectively. Each of the plurality of housing portions is provided separately from the connection portion to be attachable to and detachable from the connection portion.

This application is a continuation application of PCT International Application No. PCT/JP2023/038146, filed on Oct. 23, 2023, wherein priority is claimed on Japanese Patent Application No. 2022-186745, filed on Nov. 22, 2022. All contents of both the PCT International Patent Application and the Japanese Patent Application are incorporated herein by reference.

### TECHNICAL FIELD

The present invention relates to a connector and a connector connection structure.

### BACKGROUND ART

A connector configured to connect a device such as a battery or the like that is mounted in a vehicle or the like and a device such as a motor or the like provided in the vehicle or the like is known (see Patent Document 1). In Patent Document 1, a female battery electrical connector provided on the battery side and a male battery bay electrical connector provided on the vehicle side are disclosed. The battery electrical connector and the battery bay electrical connector include a plurality of interfaces and a mounting portion as a housing to accommodate the plurality of interfaces together.

### CITATION LIST

### Patent Documents

[Patent Document 1] JP 5882414B

### SUMMARY OF THE INVENTION

### Technical Problem

However, in the vehicle in which the above-described connector is provided, since the type and the number of the device mounted therein vary, for example, there may be a case in which the requirement for the number of interfaces being necessary for the connector or the like vary. Therefore, it becomes necessary to reset the number of the interfaces per each target in which the connector is mounted, and it becomes necessary to redesign the mounting portion or the like corresponding thereto. Also, regarding the so-called multiple connector having such plurality of interfaces, the plurality of interfaces are accommodated together in the mounting portion such that it is necessary to disassemble or exchange the whole members for repairing or the like in a case in which a continuity failure occurs in either interface. Therefore, regarding the conventional structure, costs related to the connector manufacturing, maintenance and the like tend to increase. With regard to this problem, it is considerable to provide the mounting portion for each interface, however, in this case, each interface becomes unordered so as to make it difficult to efficiently connect the interface to a mating connector.

Accordingly, an object of the present invention is to obtain a connector and a connector connection structure that is efficiently connectable regarding the connection object while improving versatility and reducing costs.

### Solution to Problem

In order to solve the above-mentioned technical problem, a connector is characterized by including a plurality of electric wires with terminals; a connection portion that retains terminals of the plurality of electric wires with terminals to be collectively connectable to mating terminals; and a plurality of housing portions that accommodate the terminals being retained by the connection portion respectively, wherein each of the plurality of housing portions is provided separately from the connection portion to be attachable to and detachable from the connection portion.

### Effect of the Invention

According to the present invention, it is possible to obtain the connector and the connector connection structure that is efficiently connectable with regard to the connection object while improving versatility and reducing costs.

### BRIEF DESCRIPTION OF THE DRAWINGS

FIG. 1 is a perspective view showing a connector and a mating connector according to an embodiment of the present invention.

FIG. 2 is a perspective view showing the connector and the mating connector when viewed from a different direction as that in FIG. 1.

FIG. 3A is an enlarged view showing a main portion of the connector in FIG. 1.

FIG. 3B is a view showing that an electric wire with terminal and a housing portion shown in FIG. 3A have been pulled out.

FIG. 4A is an enlarged view showing a main portion of the mating connector that is connected with the connector.

FIG. 4B is a view showing that a housing portion shown in FIG. 4A has been pulled out.

### DESCRIPTION OF EMBODIMENTS

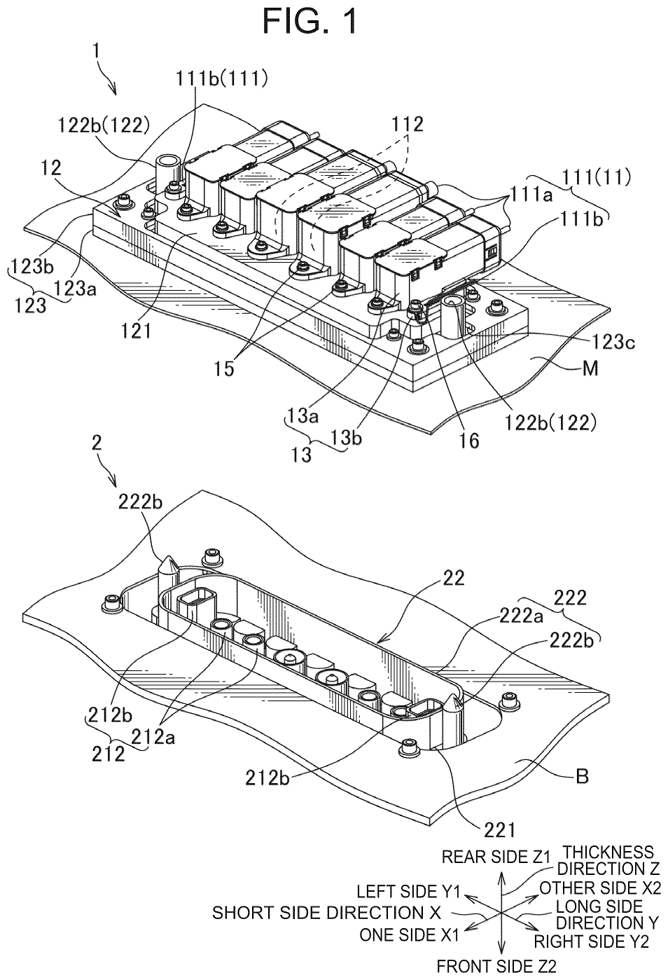

Hereinafter, a connector 1 according to an embodiment of the present invention will be described. The connector 1, for example, is a female connector configuring portion of a wire harness that is routed in a vehicle or the like, and is fixed to a first object M such as the vehicle itself or a motor of the vehicle and the like. As shown in FIG. 1, the connector 1 has an electric wire with terminal 11, a connection portion 12, and a housing portion 13. Also, in the figure, among a direction X, a direction Y, and a direction Z, each of them is orthogonal to other one.

Then, a short side direction of the connection portion 12 in the figure is referred to as a “short side direction X”. Also, one side in the short side direction X is referred to as a “one side X1”, and the other side in the short side direction X is referred to as “the other side X2”. Then, a long side direction of the connection portion 12 is referred to as a “long side direction Y”. Also, one side in the long side direction Y is referred to as a “left side Y1”, and the other side in the long side direction Y is referred to as a “right side Y2”. Also, a thickness direction of the connection portion 12 is referred to as a “thickness direction Z”. Also, one side in the thickness direction Z is referred to as a “rear side Z1”, and the other side thereof is referred to as a “front side Z2”. This is merely for facilitating the explanation, and it does not necessarily match the direction in the actual usage state, and it does not limit the direction in the actual usage state of the connector 1.

The electric wire with terminal 11, as shown in FIG. 1, has an electric wire 111 and a terminal 112 connected to the electric wire 111. The electric wires 111 are provided with a first electric wire 111a having a large diameter and through which large current flows and a second electric wire 111b having a small diameter for receiving and transmitting the electronic signals that are provided in a plural. The first electric wire 111a is a shielded electric wire shielded by a braid (not shown), and is used, for example, to supply current to the first object M. The second electric wire 111b is an electric wire without any shield structure, and is used, for example, to transmit and receive data with respect to the first object M.

According to the present embodiment, a total of six independent first electric wires 111a are arranged adjacently between a total of two independent second electric wires 111b arranged at intervals in the long side direction Y, and each of the first electric wire 111a and the second electric wire 111b extends in the short side direction X. It is noted that the number, shape, and arrangement of the electric wires 111 and the ratio of the configuration of the first electric wire 111a and the second electric wire 111b are not limited to these configurations, and various combinations can be appropriately prepared.

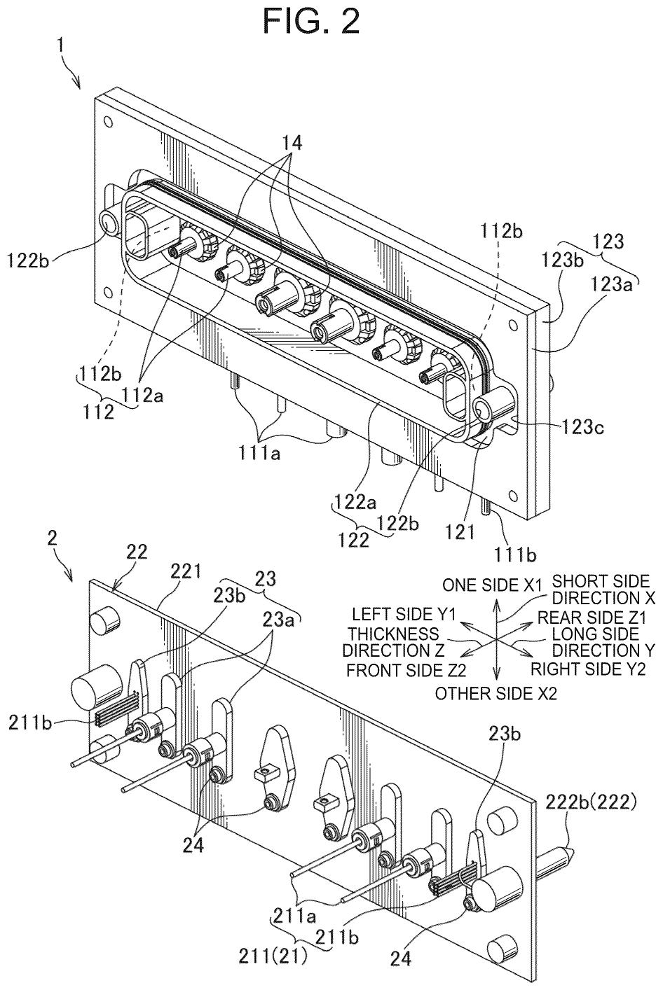

The terminal 112 is a configuration to connect the connector 1 with a male connector terminal 212 (mating terminal) (see FIG. 1) of a mating connector 2 (male connector) as a connection object, and as shown in FIG. 2, it is formed in a cylindrical shape extending in the thickness direction Z. The terminal 112 has a first terminal 112a provided at a tip of the first electric wire 111a and a second terminal 112b provided at a tip of the second electric wire 111b. Each of the first terminal 112a and the second terminal 112b is inserted through a retention portion 121 of the connection portion 12 described below in the thickness direction Z to extend and to be fixed to the retention portion 121 in this state. As shown in FIG. 2, each of the first terminals 112a is attached with a shield portion 14 that is electrically connected to the braid of the first electric wire 111a and electrically connected to the holding portion 121. The shield portion 14 surrounds the outer circumference of the first terminal 112a in the circumferential direction.

The connection portion 12 is a portion that retains the terminals 112 of a plurality of electric wires with terminals 11 so as to keep them together to be connectable with the male terminal 212. As shown in FIG. 1, the connection portion 12 includes a retention portion 121, a positioning portion 122, and a support portion 123.

As shown in FIG. 1, the retention portion 121 is configured by a substantial rectangular conductive plate member with four corners cut out, and as shown in FIG. 2, the retention portion 121 retains the terminals 112 of the electric wires with terminals 11 together in a state of being inserted through in the thickness direction Z (extending direction of the terminals 112).

The positioning portion 122 is integrally provided with the retention portion 121 at the front side Z2 (one side of the insertion direction of the terminal 112) of the retention portion 121 to be a portion fixed to the mating connector 2, and due to this fixation, the positioning portion 122 is the portion to determine the position of the terminal 112 with respect to the male terminal 212. As shown in FIG. 2, the positioning portion 122 has a fitting portion 122a and a pair of pin-receiving cylindrical portions 122b. The fitting portion 122a is formed in a frame shape, surrounds the terminals 112 together on the retention portion 121, stands up at the front side Z2, extends to the front side Z2 than the tip end portion of the terminal 112, and is opening at this direction. This fitting portion 122a is formed to fit with the fitted portion 222a of the mating connector 2 described below, and due to this fitting, the connector 1 is fixed to the mating connector 2. Also, due to this fitting, the positioning of the terminal 112 with respect to the male terminal 212 is performed.

The pair of pin-receiving cylindrical portions 122b are provided at the outside of the long side direction Y of the fitting portion 122a, wherein one thereof is adjacent to the end portion of the fitting portion 122a at the left side Y1, and the other one thereof is adjacent to the end portion of the fitting portion 122a at the right side Y2. Each of the pair of pin-receiving cylindrical portions 122b is formed in the cylindrical shape extending in the thickness direction Z to open at the front side Z2. The end portions of the pair of pin-receiving cylindrical portions 122b at the front side Z2 are positioned at the front side Z2 further than the end portion off the fitting portion 122a at the front side Z2. In the pair of pin-receiving cylindrical portions 122b, at the time of connecting the connector 1 and the mating connector 2, the positioning pin 222b described below is fitted therewith in the thickness direction Z, and due to this fitting, the positioning of the terminal 112 with respect to the male terminal 212 is performed.

The support portion 123 is a portion to be fixed to the above-described first object M using fixing members such as screws in the state of supporting the retention portion 121. That is, the support portion 123 is a configuration for fixing the connector 1 to the first object M. As shown in FIG. 1 and FIG. 2, the support portion 123 has a connection plate 123a that comes into contact with the first object M, and a support plate 123b that is stacked on the rear side Z1 of the connection plate 123a. The connection plate 123a and the support plate 123b both are formed in the rectangular plate shape having dimensions larger than that of the retention portion 121 in the short side direction X and the long side direction Y.

In the support portion 123, from the connection plate 123a to the support plate 123b, the arrangement holes 123c penetrating the thickness direction Z are formed, and inside the arrangement holes 123c, the retention portion 121 is supported in the state of being arranged therein. A length of the inner edge of the arrangement hole 123c is formed to be slightly longer than the length of the outer edge of the retention portion 121, and therefore a gap between the outer edge of the retention portion 121 and the inner edge of the arrangement hole 123c is formed. Therefore, the retention portion 121 is supported to be displaceable in the short side direction X and the long side direction Y (a crossing direction intersecting the thickness direction Z) with respect to the support portion 123 by this gap.

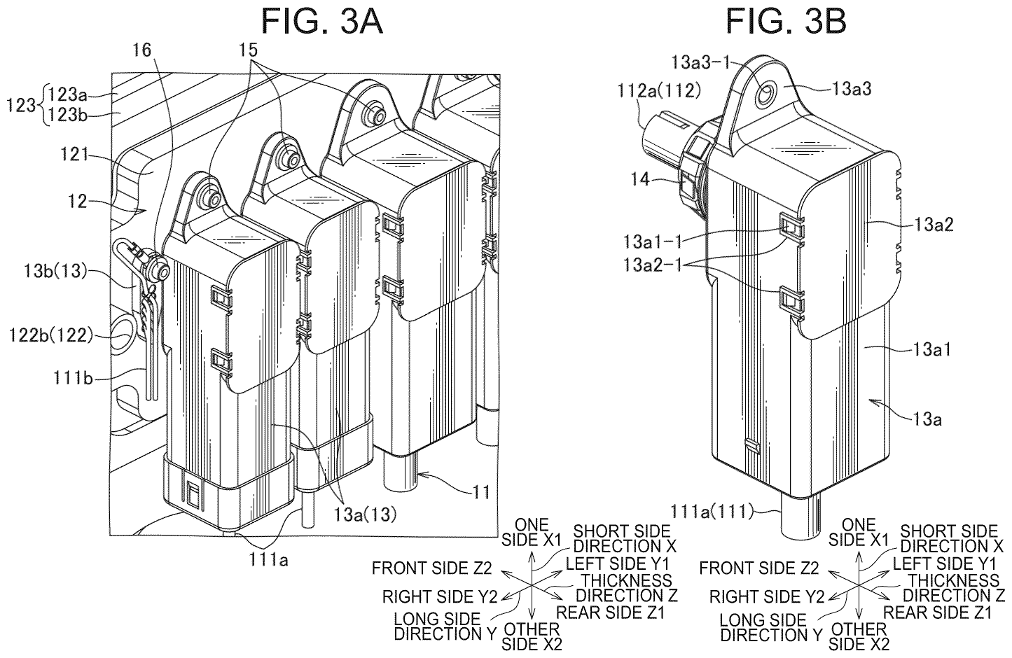

The housing portion 13 is provided separately from the connection portion 12 as a configuration to individually accommodate the plurality of terminals 112 that are retained by the connection portion 12, and a plurality of housing portions 13 are provided to correspond to each terminal 112. More specifically, as shown in FIG. 1, the housing portions 13 include a first housing portion 13a accommodating the first terminal 112a and a second housing portion 13b accommodating the second terminal 112b. As shown in FIG. 3B, the first housing portion 13a includes a box portion 13a1, a lid portion 13a2, and an attachment portion 13a3.

The box portion 13al is a portion surrounding the first electric wire 111a while being integrated with the first electric wire 111a by crimping or the like, wherein the box portion 13al is formed in a rectangular shape with a longer side in the short side direction X, and a portion at the one side X1 of the surface facing the rear side Z1 can open in the thickness direction Z. Also, even it is not shown in figures, inside this box portion 13al, a shield structure being conductive with the shield portion 14 of the first electric wire 111a (electric wire with terminal 11) while being conductive with the connection portion 12 is provided. That is, according to the present embodiment, it is possible to provide the shield structure in each of the plurality of housing portions 13.

The lid portion 13a2 is a portion that closes the openable portion of the box portion 13al, and the lid portion 13a2 is fixed to the box portion 13al by hooking claw portions 13a2-1 provided at both end portions in the long side direction Y onto projections 13a1-1 provided on the box portion 13a1. In addition, by releasing the fixation between the claw portions 13a2-1 and the projections 13a1-1, the lid portion 13a2 can be removed from the box portion 13a1, and therefore making it easy to access the inside of the box portion 13al when performing maintenance of the electric wire with terminal 11 or the like.

The attachment portion 13a3 is a portion for attaching the first housing portion 13a to the connection portion 12, and is formed in a triangular plate shape extending from the surface facing the one side X1 of the box portion 13al to the one side X1. As shown in FIG. 3A, the attachment portion 13a3 is configured such that when the first terminal 112a is inserted through the retention portion 121, the surface of the front side Z2 comes into contact with the surface facing the rear side Z1 of the retention portion 121.

The attachment portion 13a3 is provided with a screw hole 13a3-1 that penetrates in the thickness direction Z, and a first fixing screw 15 as a fastening member is screwed into this screw hole 13a3-1. By fastening and unfastening the first fixing screw 15, the first housing portion 13a, separately from the other first housing portions 13a, is attachable to and detachable from the connection portion 12. Then, by attaching and detaching an arbitrary first housing portion 13a to and from the connection portion 12, it is possible to facilitate attaching and detaching any electric wire with terminal 11 from among the plurality of electric wires with terminals 11 to and from the connection portion 12.

As shown in FIG. 3A, the second housing portion 13b is formed into an oval plate shape extending in the short side direction X. A second electric wire 111b is accommodated in the second housing portion 13b in a state of being inserted through in the thickness direction Z. In this second housing portion 13b, there is a screw hole (not shown) formed on the one side X1, and a second fixing screw 16 is screwed into this screw hole. Therefore, the second housing portion 13b, separately from other second housing portions 13b, is attachable to and detachable from the connection portion 12 by fastening and unfastening the second fixing screw 16. Then, by attaching and detaching an arbitrary second housing portion 13b to and from the connection portion 12, it is possible to facilitate attaching and detaching any second electric wire 111b from among the plurality of second electric wires 111b to and from the connection portion 12. In this manner, each of the housing portions 13 (first housing portion 13a, second housing portion 13b) is provided individually from the connection portion 12 while being attachable to and detachable from the connection portion 12.

Next, the mating connector 2 as a connection object of the connector 1 will be described. The mating connector 2 is, for example, a male connector that constitutes a portion of the wire harness routed in the vehicle or the like, and is fixed to a second object B such as the vehicle itself or a battery or the like mounted on the vehicle. As shown in FIG. 1 and FIG. 2, the mating connector 2 includes an electric wire with male terminal 21, a male connection portion 22, and a male housing portion 23. The electric wire with male terminal 21 includes a male electric wire 211 shown in FIG. 2 and a male terminal 212 (see FIG. 1) connected to the male electric wire 211.

The male electric wire 211 includes a first male electric wire 211a that forms a circuit together with the first electric wire 111a described above, and a second male electric wire 211b that forms a circuit together with the second electric wire 111b. There are six first male electric wires 211a being arranged so as to correspond to each of the first electric wires 111a. There are two male second electric wires 211b being arranged so as to correspond to each of the second electric wires 111b.

The male terminal 212 is connected to the terminal 112, and, as shown in FIG. 1, is formed into a pin shape extending in the thickness direction. The male terminal 212 includes a first male terminal 212a provided at the tip of the first male electric wire 211a, and a second male terminal 212b provided at the tip of the second male electric wire 211b.

The male connection portion 22 is a portion that retains the male terminals 212 of the plurality of electric wires with male terminals 21 so as to be connectable to the terminals 112 together. The male connection portion 22 includes a male retention portion 221 and a male positioning portion 222.

The male retention portion 221 is configured of a rectangular-shaped conductive plate member extending in the long side direction Y, and as shown in FIG. 2, the male retention portion 221 retains the male terminals 212 of the electric wires with male terminals 21 together in a state of being inserted through in the thickness direction Z (extending direction of the male terminals 212). In addition, according to the present embodiment, the male connection portion 22, being different from the above-described connection portion 12, does not have a structure as the support portion 123, and thus uses a fixing member such as the screw to directly fix the male retention portion 221 to the second object B. That is, the male retention portion 221 also functions as the configuration of fixing the mating connector 2 to the second object B.

The male positioning portion 222 is a portion being provided integrally with the male retention portion 221 on the rear side Z1 of the male retention portion 221 while being fixed to the connector 1, and due to this fixation, it is the portion to perform the positioning of the male terminal 212 with respect to the terminal 112. As shown in FIG. 1, the male positioning portion 222 includes a fitted portion 222a and a pair of positioning pins 222b. The fitted portion 222a surrounds the male terminals 212 on the male retention portion 221, stands up on the rear side Z1, extends to the rear side Z1 than the tip portion of the male terminal 212, and opens in the same direction. This fitted portion 222a stands up on the rear side Z1, and is adapted to fit into the fitting portion 122a of the connector 1 as described above.

The pair of positioning pins 222b are respectively provided at the outside in the long side direction Y of the fitted portion 222a, wherein one of which is adjacent to the end portion at the left side Y1 of the fitted portion 222a, and the other is adjacent to the end portion at the right side Y2 of the fitted portion 222a. Each of the pair of positioning pins 222b is formed in a cylindrical shape with a tapered tip extending in the thickness direction Z, and fits into the pin-receiving cylindrical portion 122b when connecting the connector 1 and the mating connector 2 as described above. The end portions at the rear side Z1 of the pair of positioning pins 222b are located at the rear side Z1 than the end portion of the fitted portion 222a at the rear side Z1.

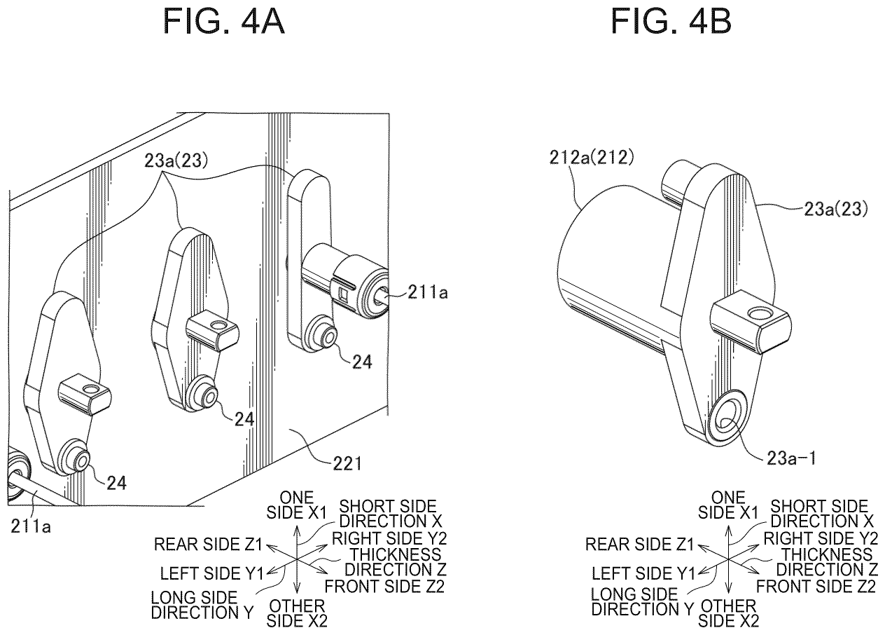

The male housing portion 23 is provided separately from the male connection portion 22 and individually accommodates each of the plurality of male terminals 212 retained by the male connection portion 22, and a plurality of male housing portions 23 are provided to correspond to each male terminal 212. More specifically, the male housing portion 23 includes a first male housing portion 23a for accommodating the first male terminal 212a and a second male housing portion 23b for accommodating the second male terminal 212b. Each of the first male housing portion 23a and the second male housing portion 23b is formed into an oval plate shape or a rhombic plate shape extending in the short side direction X. As shown in FIG. 4B, male terminal 212 is accommodated in each male housing portion 23 in a state of being inserted through in the thickness direction Z. Then, the male housing portion 23 is configured such that when the male terminal 212 is inserted through the male retention portion 221, the surface at the rear side Z1 thereof comes into contact with the surface of the male retention portion 221 facing the front side Z2.

A male screw hole 23a-1 penetrating in the thickness direction Z is formed at the other side X2 of each male housing portion 23, and a fixing screw 24 is screwed into this male screw hole 23a-1. Similarly to the housing portion 13 described above, the male housing portion 23, separately from other male housing portions 23, is attachable to and detachable from the male connection portion 22 by fastening and unfastening the fixing screws 24. Then, by attaching and detaching an arbitrary male housing portion 23 to and from the male connection portion 22, it is possible to facilitate attaching and detaching any one electric wire with male terminal 21 from among the plurality of electric wires with male terminals 21 to and from the male connection portion 22.

Next, a connection structure between the connector 1 and the mating connector 2 will be described. When connecting the connector 1 and the mating connector 2, at first, the connector 1 is fixed to the first object M, and the mating connector 2 is fixed to the second object B. More specifically, each terminal 112 of the plurality of electric wires with terminals 11 is inserted into the retention portion 121 of the connection portion 12 to retain each terminal 112. Next, the housing portion 13 that accommodates each terminal 112 is fixed to the connection portion 12 by the first fixing screw 15 or the second fixing screw 16, respectively. Then, the connector 1 in which the electric wire with terminal 11, the connection portion 12, and the housing portion 13 are integrated is brought into contact with the first object M via the connection plate 123a and then fixed to the first object M with a fixing member such as a screw or the like.

Also, each male terminal 212 of the plurality of electric wires with male terminals 21 is inserted through the male retention portion 221 of the male connection portion 22 to retain each male terminal 212 therein. Next, the male housing portion 23 that accommodates each male terminal 212 is fixed to the male connection portion 22 using the fixing screws 24, respectively. Then, the mating connector 2 in which the electric wire with male terminal 21, the male terminal 212, and the male housing portion 23 are integrated is brought into contact with the second object B via the male retention portion 221.

Next, the first object M and the second object B are arranged in the thickness direction Z. At this time, the positions are adjusted such that each terminal 112 and each male terminal 212 face each other in the thickness direction Z, the fitting portion 122a and the fitted portion 222a face each other in the thickness direction Z, and the central axis of the positioning pin 222b and the central axis of the pin-receiving cylindrical portion 122b are coincided with each other. Then, after the position adjustment, the first object M and the second object B approach each other along the thickness direction Z. When the first object M and the second object B approach each other, due to the positional relationship of the above-described configuration, at first, the positioning pin 222b begins to be inserted into the pin-receiving cylindrical portion 122b. Next, the fitting portion 122a begins to fit into the fitted portion 222a such that the connections between the terminals 112 and the male terminals 212 are collectively performed in the state in which the positions of the connector 1 and the mating connector 2 are determined. Accordingly, the connection between the connector 1 and the mating connector 2 has been completed.

It is noted that due to the installation tolerance of the connector 1 to the first object M, the installation tolerance of the mating connector 2 to the second object B and the like, it is possible that the fitting of the fitting portion 122a with respect to the fitted portion 222a may not be suitably performed. In this case, by displacing the retention portion 121 in the short side direction X and the long side direction Y with respect to the support portion 123 of the connector 1, that is, by performing the so-called floating, the misalignment between the connector 1 and the mating connector 2 can be eliminated.

Also, in a case in which the types of the first object M and the second object B change and the like, the requirements such as the number and shape of the electric wires with terminals 11 may be changed, and accordingly, it is necessary to increase or decrease the number of electric wires with terminals 11. In this case, for example, while keeping the current configuration unchanged, a new electric wire with terminal 11 is prepared and this electric wire with terminal 11 is covered with the housing portion 13 according to the present embodiment, and the housing portion 13 is fixed to the connection portion 12 such that it is easy to increase the number of the electric wires with terminals 11. Also, it is possible to easily remove the electric wire with terminal 11 from the connection portion 12 by loosening the first fixing screw 15 and removing one housing portion 13 from the current configuration.

On the other hand, if a conduction failure occurs in some of the electric wires with terminals 11 while using the first object M and the second object B, with regard to the target electric wire with terminal 11, it is possible to loosen the first fixing screw 15 to remove the housing portion 13. In this manner, it is easy to remove the electric wire with terminal 11 from the connection portion 12 to perform the inspection, reparation and replacement.

As described above, according to the embodiment described above, it is characterized that the connector 1 includes the plurality of electric wires with terminals 11, the connection portion 12 that can retain the terminals 112 of the plurality of electric wires with terminals 11 together so as to be connectable to the male terminals 212 (mating terminals), and the plurality of housing portions 13 that can individually accommodate the plurality of terminals 112 being retained by the connection portion 12, wherein each of the plurality of housing portions 13 is separately provided from the connection portion 12 and is attachable to and detachable from the connection portion 12.

According to such a configuration, due to the connection portion 12, it is possible to retain the terminals 112 of the plurality of electric wires with terminals 11 together and collectively connect them to the male terminals 212 such that the connector 1 that can be efficiently connected to the mating connector 2 can be obtained. Also, due to the plurality of housing portions 13 being provided to be separated from the connection portion 12 while being attachable to and detachable from the connection portion 12, the plurality of terminals 112 that are retained by the connection portion 12 are individually accommodated. Accordingly, even if the requirements for the number of the necessary electric wires with terminals 11 by the first object M change, for example, it is by increasing or decreasing the number of electric wires with terminals 11 for each housing portion 13, it is possible to flexibly respond to the changes in requirement by increasing or decreasing the number of electric wires with terminals 11 for each housing portion 13 while maintaining the structure of the connection portion 12 as it is. Also, regarding part of the electric wires with terminals 11, even if the requirement for the shape change, for example, it is possible to flexibly respond to the changes in requirement by changing the shape of the target housing portion 13 while maintaining the structure of the connection portion 12 as it is. Accordingly, it is possible to improve the versatility of the connector 1 and reduce the manufacturing cost of the connector 1. In addition, if a malfunction such as poor continuity occurs in any of the plurality of electric wires with terminals 11, it is possible to perform the inspection or the reparation by removing only the target electric wire with terminal 11 along with the housing portion 13. Therefore, it eliminates the need to disassemble or replace all portions of the connector, being different from the conventional multi-pole connectors. Thus, the cost on the maintenance of the connector 1 can be reduced. Accordingly, while reducing the cost and improving the versatility, it is possible to obtain the connector 1 that is efficiently connectable to the connection object.

Further, since the position of the terminal 112 relative to the male terminal 212 can be determined by the positioning portion 122 provided integrally with the connection portion 12, it is possible to definitely connect the terminal 112 to the male terminal 212.

Moreover, at this time, by fitting the fitting portion 122a to the fitted portion 222a, the position of the terminal 112 with respect to the male terminal 212 can be determined, and the connection between the terminal 112 and the male terminal 212 can be reliably established.

Further, according to the present embodiment, the support portion 123 is fixed to the first object M, and the retention portion 121 is supported so as to be displaceable in the intersecting direction with respect to the support portion 123. Therefore, when connecting the connector 1 fixed to the first object M to the male terminal 212, even if the position of the fitting portion 122a with respect to the fitted portion 222a is shifted due to the tolerance or the like, it is possible to eliminate the misalignment of the fitting portion 122a with respect to the fitted portion 222a by displacing the retention portion 121. In this manner, it is possible to perform the fitting between the fitting portion 122a and the fitted portion 222a more reliably, and to perform the connection between the terminal 112 and the male terminal 212 more reliably.

In addition, in the conventional configuration where the plurality of interfaces are housed and retained together by the mounting portion, in a case in which the plurality of interfaces are shielded wires, since it is necessary to provide the shield structure in the mounting portion to collectively shield all of the interfaces, the shield structure tends to become complicated or large. However, according to the embodiment of the present invention, the shield structure can be provided in each of the plurality of housing portions such that it is unnecessary to collectively shield all of the electric wires with terminals 11. Thus, it is possible to avoid the shield structure from becoming complicated or large.

Further, according to the present embodiment, it is possible to obtain the connector connection structure by using the connector that can improve versatility, reduce costs, and efficiently connect to the connection object.

Although the embodiment of the connector 1 has been described above in detail with reference to the drawings, the specific configuration is not limited to the embodiment, and the design change and the like without departing from the scope of the present invention should be included in the present invention.

For example, according to the present embodiment, the positioning portion 122 is configured with the fitting portion 122a and the pin-receiving cylindrical portion 122b, however, the configuration of the positioning portion 122 is not limited thereto. That is, either the fitting portion 122a or the pin-receiving cylindrical portion 122b may be omitted, or a different structure such as the claw fitting or the like may be adopted for the positioning portion 122. In any case, any structure may be used as long as it is possible to determine the positions of the plurality of terminals 112 with respect to the male terminals 212 when connecting the connector 1 and the mating connector 2.

Also, according to the present embodiment, the support portion 123 is provided in the connection portion 12 of the connector 1 to support the retention portion 121 with respect to this support portion 123 while being displaceable in the intersecting direction. However, such a configuration may be adopted in the mating connector 2 instead of the connector 1 such that the male retention portion 221 is displaceable in the intersecting direction, or the support portion 123 may be provided in both the connector 1 and the mating connector 2.

Also, according to the present embodiment, each of the housing portions 13 is provided with the shield structure, however, each shield structure may be omitted.

Also, according to the present embodiment, the female connector is described as the connector 1 and the male connector is described as the mating connector 2, however, this relationship may be reversed, wherein the male connector may be the connector 1 and the female connector may be the mating connector 2. That is, in the connector connection structure, at least one of the female connector and the male connector may be configured with the connector 1 described above.

### REFERENCE SIGNS LIST

1 connector
11 electric wire with terminal
112 terminal
12 connection portion
13 housing portion
212 male terminal (mating terminal)

What is claimed is:

1. A connector, comprising:
a plurality of electric wires with terminals;
a connection portion that retains terminals of the plurality of electric wires with terminals to be collectively connectable to mating terminals; and
a plurality of housing portions that accommodate the terminals being retained by the connection portion respectively,
wherein each of the plurality of housing portions is provided separately from the connection portion to be attachable to and detachable from the connection portion,
the connection portion comprises a retention portion that retains the plurality of electric wires with terminals in a state of inserting therethrough in an extending direction of the terminals, and a support portion provided with an arrangement hole penetrating in a thickness direction,
the support portion is fixed to an object in which the connector is arranged, and
the retention portion is supported to be displaceable with respect to the support portion in an intersecting direction intersecting to the thickness direction in a state of being arranged in the arrangement hole.

2. The connector according to claim 1,
wherein the connection portion further comprises a positioning portion that is integrally provided with the retention portion at one side in an insertion direction of the terminals and is fixed to a mating connector having the mating terminals, and
positions of the terminals with respect to the mating terminals are determined by the positioning portion being fixed to the mating connector.

3. The connector according to claim 2,
wherein the positioning portion is a frame-shaped fitting portion surrounding the terminals and standing up from the retention portion, and
the fitting portion fits into a fitted portion provided in the mating connector to be fixed.

4. The connector according to claim 1,
wherein the electric wire with terminal is a shield electric wire, and
each of the plurality of housing portions is provided with a shield structure being conductive with a shield of the electric wire with terminal while being conductive with the connection portion.

5. A connector connection structure connecting a female connector and a male connector, wherein at least one of the female connector and the male connector is configured by the connector according to claim 1.
